(19) United States
(12) Patent Application Publication
(10) Pub. No.: US 2005/0154108 A1
(43) Pub. Date: Jul. 14, 2005

(54) Floor finish with lightening agent

(76) Inventors: Minyu Li, Oakdale, MN (US); Robert D.P. Hei, Baldwin, WI (US); Lauren K. Carlson, Saint Paul, MN (US); James P. Gardner JR., Stillwater, MN (US); Paul J. Mattia, Prior Lake, MN (US)

Correspondence Address: IPLM GROUP, P.A., POST OFFICE BOX 18455, MINNEAPOLIS, MN, 55418, US

(21) Appl. No.: 10/822,636

(22) Filed: Apr. 12, 2004

Related U.S. Application Data
(63) Continuation-in-part of application No. 10/756,120, filed on Jan. 12, 2004.

(51) Int. Cl. C08K 3/10; C08K 3/18

(52) U.S. Cl. 524/409; 524/432; 524/497

(57) ABSTRACT

A jobsite-renewable floor finish comprising a film former and an appropriate amount of a lightness-inducing pigment provides a translucent hardened finish layer having an increased lightness value (as evaluated in relation to an appropriate color space) and a cleaner appearance than a finish made without such pigment.

### CROSS-REFERENCE TO RELATED APPLICATION

This application is a continuation-in-part of and claims priority to U.S. patent application Ser. No. 10/756,120, filed Jan. 12, 2004, the disclosure of which is incorporated by reference in its entirety.

### TECHNICAL FIELD

This invention relates to jobsite-renewable floor finishes, methods for applying such finishes and floors coated with such finishes.

### BACKGROUND

Jobsite-renewable floor finishes provide chemically-strippable polymeric films that can be coated on the upper surface of flooring substrates (e.g., tiles, sheet vinyl goods, wood flooring and Terrazzo) to extend the substrate use life and to provide the substrate with a desirable glossy appearance, and later removed and replaced when the finish becomes worn or soiled. Patents involving floor finishes and mentioning pigments or colorants include U.S. Pat. Nos. 4,680,237, 5,284,79, 5,851,618 and 6,472,027. Various black pigmented floor finishes have been marketed in the U.S., including ONYX™ black urethane modified acrylic sealer (commercially available from Perma, Inc.), BLACKJACK™ black plank floor finish (commercially available from JohnsonDiversey) and No. 402 glossy black floor finish (commercially available from Spartan Chemical Company, Inc.). A floor finish containing optical brightener is described in U.S. Pat. No. 4,371,398. Various finishes containing optical brighteners have been marketed in the U.S., including ISHINE™ floor finish (25% nonvolatiles, commercially available from Spartan Chemical Co.) and BETCO BEST™ floor finish (32% nonvolatiles, commercially available from Betco Corp.). Floor finishes having an abrasive-containing surface finish, and said to be made using various abrasive particulates including titanium oxides such as titanium dioxide are described in U.S. Pat. No. 5,445,670.

### SUMMARY OF THE INVENTION

Most current floor finishes are formulated to be as clear as possible to avoid yellowing, to avoid hiding the underlying flooring and to permit multiple layers to be applied over time, or are heavily pigmented to provide adequate coverage using thin coats. Clear finishes sometimes have a yellow coloration or may be prone to yellowing when weathered. Ground-in or adsorbed dirt and debris can cause discoloration of clear and pigmented finishes, as can overly-aggressive use of chemical strippers. Sometimes due to wear, high traffic, environmental conditions or other factors it is difficult to maintain an adequate protective coat atop a flooring substrate. In such instances ground-in or adsorbed dirt and debris can permanently stain or discolor the flooring substrate, Considerable effort is expended in maintaining the appearance of floors and floor finishes, including frequent washing, buffing, and periodic renewal. “Wet look” finishes are sometimes thought to have an especially desirable appearance, and some clear finishes are formulated to attain high gloss levels.

We have found that inclusion of an appropriate amount of a lightness-inducing pigment in a transparent or translucent jobsite-renewable floor finish can impart to the floor a cleaner and more desirable perceived appearance. The present invention thus provides in one aspect a jobsite-renewable floor finish comprising a film former and sufficient lightness-inducing pigment to provide a translucent hardened finish layer having an increased lightness value.

In another aspect the invention provides a floor coating method comprising applying to a flooring substrate a mixture comprising a film former and sufficient lightness-inducing pigment to provide a translucent jobsite-renewable finish having an increased lightness value.

The invention also jobsite-renewable floor finish kit comprising instructions for using the kit to apply the floor finish, wherein the kit contains a film former and sufficient lightness-inducing pigment to provide a translucent jobsite-renewable hardened finish having an increased lightness value.

### DETAILED DESCRIPTION

By using words of orientation such as “atop”, “beneath”, “on”, “under”, “uppermost”, “lowermost”, “between” and the like for the location of various layers in the disclosed finishes, we refer to the relative position of one or more layers with respect one another or where the context requires with respect to an underlying flooring substrate. We do not intend that the layers or flooring substrate must be horizontal, do not intend that the layers and flooring substrate must be contiguous or continuous, and do not exclude the presence of one or more intervening layers between layers or between the flooring substrate and a layer.

As used in connection with this disclosure, an “oligomer” is a polymerizable (e.g., crosslinkable) moiety containing a plurality (e.g., 2 to about 30) of monomer units.

As used in connection with this disclosure, a “film-former” is a monomer, oligomer or polymer that can be applied (if need be, with a suitable plasticizer or coalescing solvent) and dried, crosslinked or otherwise hardened to form a tack-free substantially durable film.

As used in connection with this disclosure, a “hardening system” is a chemical or physical process (including solvent evaporation or other drying processes, photochemical reactions, electrochemical reactions, radical processes, ionic processes, moisture cure processes and multiple-component. (e.g., two- or three-component) crosslinking processes) through which a composition becomes dried, crosslinked or otherwise cured to form a tack-free substantially durable film.

As used in connection with this disclosure, “light” is electromagnetic radiation in the visible range, approximately 4×10-7 meters to 7.7×10-7 meters.

As used in connection with this disclosure, a floor finish is regarded as being “translucent” if when coated at a 50 m2/liter coating rate atop patterned vinyl composition floor tiles (e.g., EXCELON™ vinyl composition tiles from Armstrong World Industries, Inc. having a beige background and a mottled/speckled surface pattern identified as pattern no. 51839) and died, cured or otherwise hardened, the pattern remains clearly discernible under normal daytime illumination to an observer standing on the floor.

As used in connection with this disclosure, a “lightness-inducing pigment” is a finely-divided particulate material that imparts an increased lightness value L to a hardened floor finish coated at a 50 m2/liter coating rate atop patterned vinyl composition floor tiles when evaluated using the L*a*b color space in which a value of 0 is assigned to the light reflected from a perfectly black coating and 100 is assigned to the light reflected from a perfectly white coating.

As used in connection with this disclosure, a hardened floor finish is regarded as being “jobsite-renewable” if, at such time as it may be desired to do so, the finish can be removed from an underlying flooring substrate without removing substantial portions of the flooring substrate, using simple, minimally abrasive measures such as a methylene chloride-free or acetone-free chemical stripper and a mop and detergent solution, mildly abrasive but flooring-safe measures such as a nonwoven floor scrub pad, or other measures such as peeling (and without requiring aggressive removal techniques such as grinding, sanding, sandblasting or a stripper based on methylene chloride or acetone), and then replaced with the same or a substantially similar finish and hardened to provide a visibly smooth tack-free substantially durable film.

As used in connection with this disclosure, a “multilayer floor finish” is a coating system that employs an undercoat and a topcoat of different compositions. In the interest of brevity, a layer or plurality of layers of the undercoat composition located between the flooring substrate and a topcoat may be referred to collectively as an “undercoat”, a layer or plurality of layers of the topcoat composition located atop the flooring substrate and undercoat may be referred to collectively as the “topcoat”, and a combination of a cured undercoat and topcoat (or a topcoat alone) located atop a flooring substrate may be referred to as a “coating” or “finish”.

A variety of lightness-inducing pigments nay be used in the invention. Preferably the lightness-inducing pigments have a submicron average particle diameter (and thus are smaller than particles that have been added to floor finishes to impart antislip properties) and will diffusely reflect light. Preferred lightness-inducing pigments are designated opaque or semi-opaque by the National Association of Printing Ink Manufacturers in their NPIRI Raw Materials Data Handbook. Pigments designated as food grade materials that are compatible as an indirect or direct food additive or substance such as those described in the Code of Federal Regulations (CFR), Title 21—Food and Drugs, parts 170 to 186 are also preferred. Commercially available pigments designated as “pigment whites” in the Society of Dyers and Colourists Colour Index (“C.I.”) and suitable for use in the invention include zinc oxide (Pigment White 4, C.I. 77947); lithopone (Pigment White 5, C.I. 77115), titanium dioxide (Pigment White 6, C.I. 77891); zinc sulfide (Pigment White 7, C.I. 77975); antimony oxide (Pigment White 11, C.I. 77052), zirconium oxide (Pigment White 12, C.I. 77990); barium sulfate (Pigment White 21, C.I. 77120); coprecipitated 3BaSO4/Al(OH)3 (Pigment white 23, C.I. 77122) and bismuth oxychloride (C.I. 77163). Other pigments having lightness enhancing properties which may be suitable include boron nitride; mixed titanium, chrome and antimony oxides (Pigment Brown 24, C.I. 77310); zinc sulfide (Pigment Yellow 35, C.I. 77205); mixed titanium, nickel and antimony oxides (Pigment Yellow 53, C.I. 77788); mixed titanium, nickel and niobium oxides (Pigment Yellow 161, C.I. 77895); bismuth vanadate/bismuth molybdate (Pigment Yellow 184, C. I. 771740); ACUSOL™ opacifiers (believed to be water-based styrene/acrylic emulsions) such as ACUSOL OP301, OP302P, OP303P, OP304 and OP305 (all commercially available from Rohm and Haas Co.); KESSCO™ opacifiers such as KESSCO GMS PURE glyceryl stearate, KESSCO DGMS and KESSCO DGS NEUTRAL PEG-2 stearate, KESSCO DGDS PEG-2 distearate, KESSCO PGMS PURE propylene glycol stearate and KESSCO PEG 200-6000 mono- and di-laurates, oleates and stearates (all commercially available from Stepan chemical Co.); and ammonium nonoxynol-4 sulfate (believed to be commercially available in a blend with diethanolamine/styrene/acrylates/divinylbenzene copolymer). Titanium dioxide in its rutile form and zinc oxide are especially preferred lightness-inducing pigments. Commercially available titanium dioxides include TI-PURE™ pigments from E. I. duPont de Nemours and Co. such as TI-PURE R-746 aqueous pigment dispersion and TI-PURE R-960 pigment; KEMIRA™ pigments and UV-TITAN™ pigments from Kemira Pigments Oy such as KEMIRA 660 alumina-silica-polyol surface treated rutile titanium dioxide, KEMIRA RDI-S alumina surface treated rutile titanium dioxide, KEMIRA RD3 alumina-zirconia surface treated rutile titanium dioxide and KEMIRA RDE2 and KEMIRA RDDI alumina-silica surface treated rutile titanium dioxide; TRONOX™ chloride process and TRONOX sulfate process titanium dioxide pigments from Kerr-McGee Corp.; and titanium dioxide pigments from Sun Chemical Corp. Commercially available zinc oxides include zinc oxide powders from U.S. Zinc. (available in a variety of surface areas), and “ultrafine zinc oxides” (zinc oxide having an average particle diameter or average crystallite size less than the shortest wavelength of visible light) such as NANOGARD™ zinc oxide, NANOPHASE™ zinc oxide and NANOTEK™ zinc oxide from Nanophase Technologies Corp.; NANOZINC OXIDE™ from Greencorp Magnetics Pty. Ltd.; ZnO-310 and ZnO-350 ultrafine zinc oxide from Sumitomo-Osaka Cement Co. and ZINOX™ 350 ultrafine zinc oxide from American Chemet Corp. Waterborne solutions or dispersions of lightness-inducing pigments are preferred for use with waterborne floor finish formulations, with acrylic dispersions being especially preferred for use in acrylic floor finish formulations. Mixtures of lightness-inducing pigments may also be employed.

A variety of film formers can be employed in the invention, including solvent-borne, waterborne or 100% solids compositions containing monomers, oligomers or polymers and employing a variety of hardening systems. Exemplary film formers include water-soluble or water dispersible (as is or with a dispersing agent) acid-containing polymers crosslinkable using transition metals, alkaline earth metals, alkali metals or mixtures thereof (e.g., zinc crosslinked acrylics); zinc-free acrylic finishes (e.g., acrylic copolymers); polyurethanes (e.g., radiation-curable polyurethanes, polyurethane dispersions, multipart polyurethanes and latent one part polyurethane compositions containing a blocked isocyanate); acrylic urethanes; water-based (e.g., waterborne) latex emulsions; aziridine-crosslinkable dispersions; wax emulsions; polyvinyl acetate copolymers (e.g., polyvinyl acetate-polyethylene copolymers); polyvinyl alcohol and its copolymers; polyvinylpyrrolidone and its copolymers; modified cellulose; sulfonated polystyrenes and a variety of other materials that will be familiar to those skilled in the art. Representative commercially available film formers include DURAPLUS™ 3 zinc crosslinked acrylic dispersion, RHOPLEX™ 1421 zinc crosslinked acrylic dispersion and ROSHIELD™ 3120 UV curable acrylate coating from Rohm & Haas Co.; MEGATRAN™ 205 zinc crosslinked acrylic dispersion and SYNTRAN™ 1580 zinc crosslinked acrylic dispersion from Interpolymer Corp.; MOREGLO™ zinc crosslinked acrylic dispersion from Omnova Solutions Inc.; LAROMER™ 22 WN polyester acrylate emulsion, LAROMER™ LR 8949 aqueous radiation curable aliphatic polyurethane dispersion and LAROMER™ LR 8983 aqueous radiation curable aromatic polyurethane dispersion from BASF Corp.; the ZVOC™ series of UV curable coatings from UV Coatings Limited; NEORAD™ NR-3709 UV curable aliphatic urethane coating from Zeneca Resins; VIAKTIN™ 6155 aliphatic urethane acrylate, VTE 6165 aromatic urethane acrylate and VTE 6169 aliphatic polyester urethane radiation curing resins from Solutia, Inc.; 98-283W urethane acrylate from Hans Rahn & Co.; and materials such as those described in U.S. Pat. Nos. 4,517,330, 4,999,216, 5,091,211, 5,319,018, 5,453,451, 5,773,487, 5,830,937, 6,096,383, 6,197,844, 6,228,433, 6,316,535 B1, 6,544,942 B1, U.S. patent application Publication No. US 2002/0028621 A1, and in the patents cited therein. Especially preferred film formers include water-soluble or water-dispersible film formers such as acid-containing polymers crosslinked using transition metals, and water-soluble or water-dispersible multicomponent (e.g., two component) polyurethanes. Mixtures of film formers can also be employed.

Often it will be convenient to prepare the finish by adding the lightness-inducing pigment to a commercially available floor finish material such as PADLOCK™, GEMSTAR LASER™, GEMSTAR POLARIS™ and TAJ MAHAL™ acrylic floor finishes, COURTMASTER II™ urethane floor finish and ISI STAR™, TUKLAR MEDICAL™ floor finishes from Ecolab Inc.; CORNERSTONE™ and TOPLINE™ acrylic floor finishes from 3M; BETCO BEST™ floor finish from Betco Corp.; HIGH NOON™ acrylic finish from Butchers; CITATION™ acrylic finish from Buckeye International, Inc., COMPLETE™, SIGNATURE™, TECHNIQUE™ and VECTRA™ acrylic floor finishes from SC Johnson Professional Products; OVER AND UNDER™ floor sealer from S. C. Johnson Professional Products; SPLENDOR™, DECADE 90™, PRIME SHINE™ ULTRA and PREMIER™ acrylic finishes and FIRST ROUND and FORTRESS™ urethane acrylic finishes from Minuteman, International, Inc.; ACRYL-KOTE™ Seal and Finish and PREP Floor Seal from Minuteman, International, Inc.; ULTRA TC™ and UV I-FINISH™ UV-curable finishes from Minuteman, International, Inc; FLOORSTAR™ Premium 25 floor finish from ServiceMaster, Inc.; and UPPER LIMITS™ acrylic finish and ISHINE™ optically brightened floor finish from Spartan Chemical Co. Other suitable formulations that can be combined with the pigment include No. AD200C1 polyester polyurethane formulation from Air Products and Chemicals, Inc.; No. MG98-040 polyester polyurethane formulation from Bayer AG; STAY-CLAD™ 5900 hydroxyl-functional acrylic polymer dispersion from Reichhold, Inc.; Nos. 979-1 and 980-3 polyester polyurethane formulations from U.S. Polymers, Inc.; and No. G-2029 acrylic polyurethane formulation from Zeneca Resins.

Sufficient lightness-inducing pigment should be employed in the finish to impart to the finish a noticeable increase in lightness without making the finish non-translucent. Lightness can be measured using a spectrophotometer that provides color values in the L*A*B color space (or values that can be converted thereto) from suppliers including Byk-Gardner, Color-Tec Associates, Inc., Konica Minolta, Hunter Associates Laboratory, X-Rite Inc. and others that will be familiar to those skilled in the art of color measurement. Lightness can also be assessed using the human eye, which typically is most sensitive to changes in hue and very sensitive to changes in chroma (saturation), but also is fairly sensitive to changes in lightness. As the lightness-inducing pigment particle loading initially increases, the lightness value will also increase and the floor will have a cleaner yet perceptibly natural appearance. However, as the lightness-inducing pigment particle loading increases, the coating translucency (and transmittance) will usually also be reduced The less translucent the coating, the more the underlying tile surface or underlying pattern will be masked or obliterated. Eventually at high lightness-inducing pigment particle loading levels the floor will take on an unnaturally white and even painted appearance. By balancing the particle loading level to attain an appropriate lightening effect and appropriate translucency, a cleaner-appearing yet visible coated floor can be attained. As a general numeric guide, the lightness value is greater than that of the unmodified finish and may preferably be less than about 60, may more preferably be less than about 55, and may most preferably be less than about 50.

The desired amount of lightness-inducing pigment may also depend on the chosen pigment's Hiding Power (measured as described below in the section entitled Hiding Power), with lower addition levels being preferred for high Hiding Power pigments such as titanium dioxide. As a further general numeric guide, the amount of lightness-inducing pigment that may be added to a film former may preferably be from about 1 to about 75 wt. % based on a comparison of the pigment solids weight to the total floor finish composition weight, may more preferably be about 2 to about 60 wt. %, and may most preferably be about 5 to about 50 wt. %.

A ratio calculated by dividing the Hunter whiteness index (a value provided when measuring color values using a Hunter Labs color spectrophotometer) by the 500 nm absorbance coefficient also may provide a useful measure of appearance merit. As the lightness-inducing pigment particle loading initially increases, the ratio will decrease. As a general numeric guide, coatings whose whiteness index:absorbance coefficient ratio remains above about 40, and more preferably above about 80 may be preferred, whereas a finish having a ratio of about 30 may appear overly white with undesirable masking or hiding of the underlying tile pattern.

A further ratio calculated by dividing the lightness value L by the Hiding Power also may provide a useful measure of appearance merit. As the lightness-inducing pigment particle loading initially increases, the ratio will increase. As a general numeric guide, coatings whose L:Hiding Power ratio remains above about 30, and more preferably above about 35 may be preferred.

If added to a topcoat, the lightness-inducing pigments preferably are added at levels that do not objectionably reduce the coating 20° gloss level as hardened (or if need be, as buffed or burnished). The degree of gloss reduction that may be objectionable will vary depending on the particular application. As a general numeric guide, gloss level reductions less than 25 absolute points (on a 100 point scale), and more preferably less than 10 points are preferred. If added to an undercoat (or to a buried topcoat layer that will be overcoated with a topcoat layer containing no or a lower level of lightness-inducing pigments) then usually a greater degree of gloss reduction can be tolerated as it may be compensated for by application of the topcoat. Even if not overcoated with a topcoat, the overall appearance improvement provided by the enhanced lightness level can sometimes offset a substantial degree of gloss reduction, yielding a finish that will be perceived as having a better appearance despite a considerably reduced gloss level.

Preferably the lightness-inducing pigment and film former are combined using stirring or other methods that will be apparent to those skilled in the art. The addition can take place well prior to or at a job site.

The floor finish may also contain water or another suitable diluent, plasticizer or coalescent, including compounds such as benzyloxyethanol; an ether or hydroxyether such as ethylene glycol phenyl ether (commercially available as “DOWANOL EPh” from Dow Chemical Co.) or propylene glycol phenyl ether (commercially available as “DOWANOL PPh” from Dow Chemical Co.); dibasic esters such as dimethyl adipate, dimethyl succinate, dimethyl glutarate, dimethyl malonate, diethyl adipate, diethyl succinate, diethyl glutarate, dibutyl succinate, and dibutyl glutarate (including products available under the trade designations DBE, DBE-b 3, DBE-4, DBE-5, DBE-6, DBE-9, DBE-IB, and DBE-ME from DuPont Nylon); dialkyl carbonates such as dimethyl carbonate, diethyl carbonate, dipropyl carbonate, diisopropyl carbonate, and dibutyl carbonate; phthalate esters such as dibutyl phthalate, diethylhexyl phthalate, and diethyl phthalate; and mixtures thereof. Cosolvents can also be added if desired to assist in formulating and applying the finish. Suitable cosolvents include Butoxyethyl PROPASOL™, Butyl CARBlTOL™ acetate, Butyl CARBITOL™, Butyl CELLOSOLVE™ acetate, Butyl CELLOSOLVE™, Butyl DIPROPASOL™, Butyl PROPASOL™, CARBITOL™ PM-600, CARBITOL™ Low Gravity, CELLOSOLVE™ acetate, CELLOSOLVE™, Ester EEP™, FILMER IBT™, Hexyl CARBITOL™, Hexyl CELLOSOLVE™, Methyl CARBITOL™, Methyl CELLOSOLVE™ acetate, Methyl CELLOSOLVE™, Methyl DIPROPASOL™, Methyl PROPASOL™ acetate, Methyl PROPASOL™, Propyl CARBITOL™, Propyl CELLOSOLVE™, Propyl DIPROPASOL™ and Propyl PROPASOL™, all of which are available from Union Carbide Corp.; and mixtures thereof. The concentration may vary depending in part on the other finish ingredients and on the intended application and application conditions. As a general guide, when water alone is used as a diluent, the water concentration preferably is from about 15 to about 98 wt. % based on the finish formulation weigbt. More preferably, the finish contains about 25 to about 95 wt. % water, and most preferably about 60 to about 95 wt. % water. If a diluent, plasticizer. coalescent or cosolvent other than water is included in the finish formulation, then its concentration preferably is from about 0.1 to about 10 wt. % based on the weight of polymerizable solids in the finish, and more preferably about 1 to about 7 wt. %.

The floor finish may contain one or more initiators, catalysts or crosslinkers capable of hardening the film former. For example, depending in part on the chosen film former, the floor finish may contain transition metal compounds such as zinc or zirconium compounds; tin compounds such as dibutyl tin dilaurate, stannous octoate and FASCAT™ 4224 dibutyltin bis(1-thioglycerol) catalyst (commercially available from ATOFINA Chemicals, Inc.); amines; other zinc compounds such as zinc crosslinked acrylic dispersions (described further in application Ser. No. 10/755,972 entitled AQUEOUS POLYURETHANE COATING SYSTEM CONTAINING ZINC CROSSLINKED ACRYLIC DISPERSION, filed Jan. 12, 2004, the disclosure of which is incorporated herein by reference), ultrafine zinc oxide (described further in application Ser. No. 10/755,975 entitled POLYURETHANE COATING CURE ENHANCEMENT USING ULTRAFINE ZINC OXIDE, filed Jan. 12, 2004, the disclosure of which is incorporated herein by reference), zinc carbonates including zinc tetraamine carbonate and zinc ammonium carbonate (described further in application Ser. No. 10/755,976 entitled POLYURETHANE COATING CURE ENHANCEMENT USING ZINC CARBONATE INITIATORS, filed Jan. 12, 2004, the disclosure of which is incorporated herein by reference); and a variety of other materials that will be familiar to those skilled in the art.

The floor finish may also contain inorganic or organic particles (or both inorganic and organic particles) to enhance its abrasion resistance, scratch resistance, wear resistance or strippability. Preferred inorganic particles are described in copending U.S. patent application Ser. No. 09/657,420 filed Sep. 8, 2000 and entitled SCRATCH-RESISTANT STRIPPABLE FINISH, the disclosure of which is incorporated herein by reference. It should be noted that the inorganic particles in the UV-curable finishes exemplified in the latter reference did not diffusely reflect light.

The floor finish can contain a variety of adjuvants to alter its performance or properties before or after application to a floor. Useful adjuvants include flatting agents, surfactants, surface slip modifiers, defoamers, waxes, indicators, UV absorbers, light stabilizers, antioxidants, plasticizers, coalescents and adhesion promoters. The types and amounts of such adjuvants will be apparent to those skilled in the art.

The lightness-inducing pigments can be employed in one or more layers of multilayer floor finish compositions. Representative multilayer floor finish compositions are described in application Ser. No. 09/560,170 entitled STRIPPABLE LAMINATE FINISH filed Apr. 28, 2000, the disclosure of which is incorporated herein by reference; application Ser. No. 09/838,884 entitled STRIPPABLE LAMINATE FINISH filed Apr. 20, 2001, the disclosure of which is incorporated herein by reference; application Ser. No. 10/756,119 entitled JOBSITE-RENEWABLE MULTILAYER FLOOR FINISH WITH ENHANCED HARDENING RATE, filed Jan. 12, 2004, the disclosure of which is incorporated herein by reference; and in Published PCT Application No. WO 98/11168 (Hamrock et al.).

The disclosed floor finishes can be applied to a variety of substrates, including wood, plastics, metals, concrete, wallboard and other mechanical or architectural substrates. The disclosed finishes are particularly well-suited for application to flooring substrates due to their clean appearance. Representative flooring substrates include resilient substrates such as sheet goods (e.g., vinyl flooring, linoleum or rubber sheeting), vinyl composite tiles, rubber tiles, cork and synthetic sports floors, and non-resilient substrates such as concrete, stone, marble, wood, ceramic tile, grout, Terrazzo and other poured or “dry shake” floors. The coating can be jobsite-applied to a flooring substrate after the substrate has been installed (e.g., to monolithic flooring substrates such as sheet vinyl goods, linoleum, cork, rubber sheeting, synthetic sports floors, concrete, stone, marble, grout or Terazzo, or to multipiece flooring substrates such as vinyl composite tiles, wood floorboards or ceramic tiles), or can be factory-applied to a flooring substrate before it is installed (e.g., to monolithic flooring substrates such as sheet vinyl goods in roll form, or multipiece flooring substrates such as vinyl composite tiles or wood floorboards). Jobsite application is especially preferred, with suitable jobsites including indoor and outdoor sites involving new or existing residential, commercial and government- or agency-owned facilities.

The disclosed finishes can be applied using a variety of methods, including spraying, brushing, flat or string mopping, roll coating and flood coating. Mop application, especially flat mopping, is preferred for coating most floors. Suitable mops include those described in U.S. Pat. Nos. 5,315,734, 5,390,390, 5,680,667 and 5,887,311. Typically, the floor should first be cleaned and any loose debris removed. One or more undercoat layers or coats (diluted if necessary with water or another suitable diluent, plasticizer, coalescent or cosolvent) may be applied to the floor. One to three undercoat layers typically will be preferred. When multiple undercoat layers are employed they can be the same or different. Each undercoat layer preferably will have a dry coating thickness of about 2.5 to about 25 μm, more preferably about 2.5 to about 15 μm. Preferably the overall undercoat dry coating thickness will be about 5 to about 100 μm, and more preferably about 5 to about 50 μm.

One or more (e.g., one to three) topcoat layers may be applied to the floor or to the undercoat. Each topcoat layer preferably will have a dry coating thickness of about 25 to about 200 μm, more preferably about 2.5 to about 100 μm. Preferably the overall topcoat dry coating thickness will be relatively thin in order to reduce raw material costs, e.g., about 5 to about 150 μm, and more preferably about 5 to about 40 μm. Multilayer finishes preferably will have an overall dry coating thickness of about 10 to about 500 μm, and more preferably about 10 to about 80 μm.

The floor can be placed into service (or returned to service) once the finish has hardened sufficiently to support normal traffic without marring. As described further in the above-mentioned application Ser. No. 10/755,975, use of ultrafine zinc oxide in the undercoat or topcoat of a multilayer finish system employing a 2K polyurethane topcoat also promotes faster topcoat cure and enables the floor to be subjected to normal traffic much earlier than if ultrafine zinc oxide is not employed.

The finish can receive normal maintenance until such time as it is desired to remove and renew it. Removal can be carried out, for example, by cleaning the floor (using e.g., a brush or mop) followed by application of a stripper. The chosen stripper may include compositions containing phenyl alcohols (e.g., benzyl alcohol); alkoxy ethers (e.g., glycol ethers such as propylene glycol methyl ether and ETHYL CARBlTOL™, BUTYL CARBITOL™ and BUTYL CELLOSOLVE™ solvents from Union Carbide Corp.); alkoxy esters; aryloxy alcohols (e.g., phenoxy ethanol and phenoxy propanol); dibasic esters; N-alkyl pyrrolidones, ketones, esters, metasilicates; amines (e.g., ethanolamine); alkanolamines (e.g., monoethanolamine); acid based agents and caustic agents (e.g., sodium or potassium hydroxide). Strippers containing phenyl alcohols are especially preferred for stripping multilayer finishes employing polyurethane topcoats owing to the relatively high rate at which phenyl alcohols may penetrate such topcoats and their ease of use and low odor. A particularly preferred stripper concentrate contains a polar solvent that is denser than water and a sufficiently low level of cosolvent or surfactant so that upon mixing with water a pseudo-stable aqueous dispersion forms which will phase-separate following application to a surface. Concentrates of this type are described in U.S. Pat. No. 6,544,942. Another preferred stripper concentrate contains about 1 to 75 wt. percent of an ether alcohol solvent having a solubility in water of less than about 5 wt. % of the solvent, and about 1 to 75 wt. % of an ether alcohol solvent/coupler having a solubility in water of about 20 to about 100 wt. % of the solvent/coupler, wherein the vapor pressure of the concentrate is less than 1 millimeter Hg. Concentrates of this type are described in U.S. Pat. No. 6,583,101. The stripper can contain a variety of adjuvants to alter the performance or properties of the stripper before or after application to a cured polyurethane finish. Useful adjuvants include abrasive particles, surfactants, defoamers, indicators, slip reducing agents, colorants and disinfectants. The types and amounts of such adjuvants will be apparent to those skilled in the art.

The stripper should be allowed to stand for a suitable time (e.g., for a minute or more, preferably for two hours or less, and most preferably for between about 5 minutes and about 1 hour) while it softens the finish. After the finish softens sufficiently it can be removed using a variety of techniques including scrubbing, vacuuming, mopping, use of a squeegee, scraping, sweeping, wiping, mild abrasion or other measures that do not remove substantial portions of the floor. Removal will usually be made easier if water or a suitable detergent solution is applied to the softened finish. The floor can be allowed to dry and new layers of the undercoat and polyurethane applied to renew the finish.

Multilayer finishes typically will be sold in the form of a kit including the undercoat and topcoat in suitable containers or dispensers together with suitable instructions for mixing or dispensing any undercoat and topcoat components as needed and for applying the undercoat atop a floor and applying the topcoat atop the undercoat. If desired, the undercoat or topcoat could be packaged as concentrates intended to be mixed with water or another suitable solvent prior to application. The lightness-inducing pigment may be included in an undercoat or topcoat component or packaged separately and mixed with the topcoat or undercoat shortly before application to a floor. Optionally the kit may include a stripper concentrate in a suitable container. The stripper concentrate typically will be mixed with water or another suitable carrier at, for example, about 5-30% by weight acive ingredients prior to application- The kit can also contain additional undercoat materials (e.g., leveling coatings) that can be applied to the floor before application of the undercoat and topcoat, or various additional materials (e.g., maintenance coats or wax finishes) that can be applied atop the topcoat. Maintenance coats typically will be applied when the initially-applied multilayer floor finish exhibits noticeable wear or loss of gloss, and typically will be applied at solids levels that are the same as or somewhat less than the solids levels of the initially-applied topcoat.

If desired, the multilayer floor finishes can also be factory-applied to a variety of flooring substrates. For example, when factory-applied to a multipiece flooring material, the pieces typically will be coated on at least the top surface and optionally coated or partially coated on the side or bottom surfaces.

The invention is further illustrated in the following non-limiting examples, in which all parts and percentages are by weight (wt.) unless otherwise indicated.

### Tile Preparation

Evaluations were performed using both new and used vinyl composition tiles. New tile surfaces were cleaned and roughened until no longer shiny by rubbing with MAGICSCRUB™ mild abrasive cleaner (commercially available from Ecolab Inc.) using a non-woven SCOTCH-BRlTE™ green abrasive scrub pad (commercially available from 3M Company). The cleaned new tiles were rinsed with tap water and dried at room temperature. This removed all factory applied coatings and surface soil, and provided a consistently reproducible surface. Used tile surfaces were stripped of residual finish and residue using a 1:8 dilution of the commercial stripper CARESTRIP™ LO (commercially available from Ecolab, Inc.). If that was not sufficient to remove the residual finish the tile surfaces were further stripped using a 13% dilution of the stripper shown below in Table 1:

TABLE 1
Stripper

| Ingredient | Parts |
|---|---|
| Benzyl Alcohol⁽¹⁾ | 57.03 |
| Monoethanolamine, 99%⁽²⁾ | 22.81 |
| Diethylene glycol monobutyl ether⁽³⁾ | 5.703 |
| Dipropylene glycol n-butyl ether⁽⁴⁾ | 5.703 |
| Propylene glycol phenyl ether⁽⁵⁾ | 5.703 |
| Surface active agent⁽⁶⁾ | 1.901 |
| Wetting agent⁽⁷⁾ | 0.115 |
| Deionized water | 1.035 |
| TOTAL | 100 |

⁽¹⁾Benzyl alcohol, technical grade, Velsicol Chemical.
⁽²⁾Monoethanolamine, 99%, Dow Chemical.
⁽³⁾Diethylene glycol monobutyl ether, 99%, Equistar.
⁽⁴⁾Dipropylene glycol n-butyl ether, 98.5%, Dow Chemical.
⁽⁵⁾Propylene glycol phenyl ether, Dow Chemical.
⁽⁶⁾Linear Alcohol (C12-15) ethoxylate 9 EO, Rhodia.
⁽⁷⁾ZONYL ™ FSJ, 40% active, E. I. duPont de Nemours and Co..

The stripped used tiles were rinsed with tap water and allowed to dry at room temperature. This provided a cleaned surface like the surface that might be encountered under field conditions.

### Percent Solids

Percent solids values for formulated coatings were calculated based on the raw material percent solid values and their proportion in the formulated coatings. Percent solids values for commercial products (e.g., paints, sealers and stains) not identified by the manufacturer were determined using a Model HB43 halogen moisture analyzer, (commercially available from Mettler-Toledo International, Inc.) and a 105° C. drying temperature, with the measurement being halted once the mean weight change fell below 0.1 mg/s.

### Film Evaluation

The coated tiles were evaluated to assess strippability, gloss, color, transparency, absorbance and visual appearance, as follows;

### Strippability

Chemical-physical removability (strippability) was evaluated by affixing an adhesive-backed foam ring to the coating surface. The inner portion of each ring was filled with a diluted solution (at ratios noted below) of the commercial stripper CARESTRIP™ LO (commercially available from Ecolab, Inc.). The stripper was allowed to contact the coating surface for time periods noted below and then poured out of the ring. The coated or stripped surface was rinsed with tap water. The treated area was viewed in relation to the untreated area by peeling the foam ring away from the coating and briefly wiping with a paper towel to remove loose coating material. A visually determined percent coating removal was recorded, with higher removal values indicating more removable coatings and a 100% value indicating complete removal.

### Gloss

Film gloss was measured at 20° and 60° using a Micro-TRI-Gloss meter (commercially available from Paul N. Gardner Co., Inc.). An average of readings at 4 to 6 discrete points on the coating surface was determined.

### Coating Color Values

Coating color values were evaluated using a MINISCAN™, XE Plus or a COLORQUEST™ XE color spectrophotometer (both commercially available from Hunter Associates Laboratory). The former instrument is a hand-held device that is especially useful for evaluating a coated floor, while the latter instrument is a benchtop device that is especially useful for evaluating individual coated tiles. Both instruments measure the reflectance spectrum of a surface and output color values in L*A*B coordinates. These coordinates can be used to calculate parameters including lightness (L), whiteness index (WI), yellow index (YI) and paper brightness (Z %). A D65 illuminant was used at a 10° observer angle. All color values were determined from an average of readings at 6 to 8 discrete points on the coating surface or substrate.

### Transmittance and Absorbance

Coating transmittance was measured by applying one or more coats of a coating solution at various wet coating thicknesses reported below onto a 0.0127 mm thick clear polyester sheet (commercially available from GE Polymershapes). The film was allowed to air dry and its % transmittance measured at discrete wavelengths reported below using a SPECTRONIC GENESYS™ 5 TV-Visible spectrometer (commercially available from Thermo Electron Corp.). An uncoated polyester sheet (or in some instances a sheet coated with various unmodified finishes described below) was used as a reference or control sample. Absorbance values were calculated from the % transmittance values using the equation A=−log(T) where A is the absorbance value and T is the absolute transmittance value (the percent transmittance divided by 100).

### Hiding Power

Hiding Power was determined by applying one or more layers of a formulation to LENETA™ Form 24B Gray Scale charts (commercially available from the Leneta Company) using a No. 10 Bar from the Paul N. Gardner Co. and air drying between layers, to provide coatings having an approximate overall dry coating thickness of about 0.015 mm. The resulting coated films were allowed to air dry for at least 24 hours, then evaluated by having an observer located three meters from the coated gray scale chart record the first gray scale bar that could be clearly differentiated from a white background. Higher observed gray scale bar values corresponded to coatings with greater Hiding Power and a better capability to mask an underlying surface.

### EXAMPLE 1

Two 1.4 m×1.8 m sections of a laboratory hallway floor were stripped as described above in the section entitled Tile Preparation, then coated with two layers of an undercoat and a single layer of a two-component polyurethane topcoat. The hallway flooring material was 0.3 m×0.3 m EXCELON™ vinyl composition tiles (commercially available from Armstrong World Industries, Inc.) having a beige background and a mottled/speckled surface pattern identified as pattern no. 51839. This hallway had been in use for over 5 years and had undergone normal wear and tear associated with moderate levels of foot traffic. The first floor section undercoat was formed from two layers of PADLOCK™ acrylic polymer floor finish (16% nonvolatiles, comnmercially available from Ecolab, Inc.), applied using a commercially available microfiber pad and a 50 m²/liter wet coating rate. A 30 minute drying time was allowed between layers. The second floor section undercoat was formed from a single layer made by mixing 13.2% of an aqueous dispersion of NANOTEK™ No. Z1021W ultrafine zinc oxide dispersion in water (49% nonvolatiles, commercially available from Nanophase Technologies Corp.) with 86.8% of PADLOCK acrylic floor finish. Following application of the undercoat, the coated hallway sections were allowed to air dry for 1.5 hours. Identical topcoats were then applied to each coated hallway section, using a single layer of the two-component polyurethane (“2K PUR”) topcoat formulation shown below in Table 2. The polyurethane topcoat formulation was mixed prior to application by combining Part A and Part B according to the weight ratios shown below, mixing vigorously for 3 minutes and then allowing the mixture to stand for 10 to 12 minutes before application at a 16 to 18.4 m²/liter wet coating rate.

TABLE 2
2K PUR Topcoat

| | Ingredient | Parts by Weight |
|---|---|---|
| Part A | Polyester polyol⁽¹⁾ | 88.90 |
| | Silicone defoamer⁽²⁾ | 0.13 |
| | Surface agent⁽³⁾ | 0.06 |
| | Surface agent⁽⁴⁾ | 1.16 |
| | Deionized water | 9.75 |
| Part B | Hexamethylene | 39.78 |
| | diisocyanate⁽⁵⁾ | |
| | Hydrophilic | 100 |
| | hexamethylene | |
| | diisocyanate⁽⁶⁾ | |
| Mix Ratios | Part A | 22.5 |
| | Part B | 7.5 |

⁽¹⁾BAYHYDROL ™ XP-7093, 30% nonvolatiles, Bayer Corporation.
⁽²⁾BYK ™ 025, BYK Chemie.
⁽³⁾BYK ™ 348, BYK Chemie.
⁽⁴⁾BYK ™ 380, BYK Chemie.
⁽⁵⁾DESMODUR ™ N-3600, Bayer Corporation.
⁽⁶⁾BAYHYDUR ™ XP-7165, Bayer Corporation.

The topcoated hallway sections were allowed to dry overnight at room temperature. Both sections were observed to have a tack-free, glossy film surface and sufficient translucency to allow the underlying tile pattern to be discerned. However, the section undercoated with the zinc-oxide modified undercoat (viz., the second section) appeared to observers as being noticeably “lighter”, “whiter” or “brighter” than the first section. The overall impression was that the second section was much cleaner than the first section.

### EXAMPLE 2

A visual survey was carried out in the same hallway two months after the finishes described in Example 1 were applied. Individual tiles in the two sections were compared to two tiles within the section coated with commercially available acrylic floor finishes containing optical brighteners atop a conventional acrylic floor finish, and one tile within the section coated only with the conventional acrylic floor finish. Each of these tree comparison tiles was first coated with a single layer of GEMSTAR LASER™ acrylic finish (20% nonvolatiles, commercially available from Ecolab, St. Paul, Minn.) and allowed to dry. All three tiles were next washed with water to provide a clean surface. Two of the tiles were further coated the day before the survey with two layers of ISHINE™ optically brightened floor finish (25% nonvolatiles, commercially available from Spartan Chemical Co.) or two layers of BETCO BEST™ optically brightened floor finish (32% nonvolatiles, commercially available from Betco Corp.) using a microfiber pad, a 50 m²/liter wet coating rate and a one-hour drying time between layers.

On the following day the visual survey was performed. Six observers who were unfamiliar with the project and its goals were asked to rank the hallway section tiles and the three comparison tiles using the numerical whiteness ranking set out below in Table 3:

TABLE 3

| Rank | Description |
|---|---|
| 5 | Tile looks unnaturally white, and its underlying |
| | pattern is masked |
| 4 | Tile looks bright and clean and has white |
| | undertones |
| 3 | Tile looks clean; may still have beige to |
| | yellow tones |
| 2 | Tile has slight dinginess, but its overall |
| | appearance is okay |
| 1 | Tile is dirty; brown to yellow in color |

Each observer was first shown a “dirty” tile deemed to have a rank of 1 and a “white” tile deemed to have a rank of 5. The dirty tile was located in the same hallway near the above-mentioned first and second sections. It had been stripped two months earlier, not recoated, and subjected to normal hallway traffic for two months, causing it to become very discolored and dirty. The white tile was made by removing the factory applied finish from a new EXCELON tile as described above in the section entitled Tile Preparation and coating the thus-cleaned surface with two layers of Extra White CUPRINOL™ Solid Color Deck Stain (˜56% nonvolatiles determined as described above in the section entitled Percent Solids, commercially available from Sherwin Williams Co., diluted to 20% nonvolatiles using water). The stain was applied using the same procedure used above to apply the optically brightened finishes. The underlying pattern on the resulting coated tiles was largely obliterated, with only a few remnants of the pattern being visible through the white coating. This tile was included in the survey in order to provide a coated white endpoint, not a desired appearance target, since the tile had a dead, unnatural appearance and its underlying pattern could no longer effectively serve its original ornamental and dirt- and debris-masking purposes. The visual survey ranking results and the measured whiteness index and gloss values are shown below in Table 4:

TABLE 4

| | | Average | | | Whiteness |
|---|---|---|---|---|---|
| Run | | Survey | 60° | 20° | Index, |
| No. | Description | Ranking | Gloss¹ | Gloss¹ | WI² |
| 2-1 | New untrammeled tile | 5 | 6.7 | 1.3 | 33.3 |
| | coated with 2 layers | | | | |
| | diluted CUPRINOL deck | | | | |
| | stain | | | | |
| 2-2 | Aged walked-upon tiles | 4.1 | 75.0 | 35.4 | 21.87 |
| | coated with 2 layers | | | | |
| | ZnO-modified | | | | |
| | PADLOCK finish and 1 | | | | |
| | layer 2K PUR finish | | | | |
| 2-3 | Aged walked-upon tiles | 3.1 | 82.6 | 54.2 | 13.53 |
| | coated with 2 layers | | | | |
| | PADLOCK finish and 1 | | | | |
| | layer 2K PUR finish | | | | |
| 2-4 | Tile freshly coated with 1 | 2.8 | 40.7 | 13.4 | 3.62 |
| | layer GEMSTAR | | | | |
| | LASER finish | | | | |
| 2-5 | Tile freshly coated with 2 | 2.1 | 87.8 | 60.5 | 14.53 |
| | layers ISHINE optically | | | | |
| | brightened finish over 1 | | | | |
| | layer GEMSTAR | | | | |
| | LASER finish | | | | |
| 2-6 | Tile freshly coated with 2 | 2.1 | 84.2 | 61.0 | 9.62 |
| | layers BETCO BEST | | | | |
| | optically brightened | | | | |
| | finish over 1 layer | | | | |
| | GEMSTAR LASER | | | | |
| | finish | | | | |
| 2-7 | Aged walked-upon bare, | 1 | 9.2 | 1.4 | 1.06 |
| | dirty tile | | | | |

¹= Average gloss reading of 6 different points on 304 mm × 304 mm tile.
²= Average color value measurement of 8 different areas on 304 mm × 304 mm tile.

The observers preferred the appearance of tiles coated with the zinc oxide-modified undercoat (Run No. 2-2) over all other tiles having a numerically lower or higher survey ranking. Surprisingly, the expressed appearance preferences did not correlate with gloss or whiteness measurements obtained for the various coatings. For example, tiles coated with ISHINE finish (Run 2-5) or with BETCO BEST finish (2-6) had much higher gloss than the floor section coated with the zinc oxide-modified undercoat (Run 2-2) or tiles coated with GEMSTAR LASER finish (Run 2-4), but the appearance of tiles coated with these optically brightened finishes was not preferred by the observers. Also, the white reference tile (Run No. 2-1) had a greater perceived whiteness than all other tiles, but its appearance was not preferred. The expressed observer preferences for the coating in Run No. 2-2 are believed to be due in large part to the combination of lightness and translucency imparted by the modified undercoat and a corresponding impression that the finish or tile is cleaner.

### EXAMPLE 3

Using the method of Example 1, a series of 1.4 m×1.2 m floor sections in the Example 1 hallway were coated with two layers of an undercoat containing varying amounts of zinc oxide followed by a single layer of the polyurethane topcoat shown in Table 2. The whiteness index of each coating was recorded. The results are shown below in Table 5:

TABLE 5
Weight % ZnO Dispersion in Undercoat Layers

| | | | Whiteness |
|---|---|---|---|
| Run No. | Layer 1 | Layer 2 | Index (WI) |
| 3-1 | 0 | 0 | 3.89 |
| 3-2 | 0 | 11.5 | 4.89 |
| 3-3 | 0 | 17.3 | 8.57 |
| 3-4 | 11.5 | 11.5 | 21.51 |

The data in Table 5 show that higher zinc oxide levels in the undercoat provided whiter and perceptibly lighter and cleaner appearing) coatings. All coatings remained translucent and the underlying tile pattern remained readily discernible.

### EXAMPLE 4

A series of acrylic floor finishes containing zinc oxide or titanium dioxide particle dispersions was formulated. The particle dispersion concentrations and number of coats applied were varied in order to illustrate effects upon the gloss, whiteness, and transparency of the resulting coatings. The particle dispersions were added to GEMSTAR LASER acrylic floor finish as employed in Example 2. The zinc oxide dispersion was the same as in Examples 1 and 2. The titanium dioxide dispersion was TI-PURE™ Slurry R-746, an aqueous pigment dispersion containing 76.4% nonvolatiles (commnercially available from E. I. duPont de Nemours and Co.). Water was added to each undercoat formulation to maintain a constant 20% solids level. The formulations are shown below in Table 6.

TABLE 6

| | Lightness- | Wt % | | Wt % |
|---|---|---|---|---|
| Formulation | Inducing | particle | Wt % | particles in |
| No. | Pigment | dispersion | water | dried coating |
| 4-1 | ZnO | 1.9 | 3.0 | 4.9 |
| 4-2 | ZnO | 8.4 | 13.3 | 21.8 |
| 4-3 | TiO₂ | 1.3 | 3.6 | 5.0 |
| 4-4 | TiO₂ | 5.7 | 16.0 | 21.7 |

A commercially available deck stain (Extra White CUPRINOL™ Solid Color Deck Stain as used in Example 2, diluted to 20% nonvolatiles using water) and a deck seal (CUPRINOL UV Sun Block Deck and Wood Seal, clear base with 3503 white birch tint, 14% nonvolatiles determined as described above in the section entitled Percent Solids, commercially available from Sherwin Williams Co.) were also evaluated. White vinyl composition tiles (commercially available from the Congoleum Corporation, cleaned as described above in the section entitled Tile Preparation) were coated with the Table 6 formulations or with the commercial products. The transmittance and absorbance of each coating formulation or commercial product was also evaluated as described above in the section entitled Transmittance and Absorbance. Formulations 4-1 through 4-4 were applied to four white tiles and four polyester sheets using 1, 2, 3 or 4 layers of the formulation and a No. 7 drawdown bar (0.018 mm wet thickness, commercially available from the Paul N. Gardner Co.), then overcoated with 3, 2, 1 or no layers of GEMSTAR LASER acrylic finish. At least 30 minutes drying time was allowed between layers. This procedure yielded test panels having a coating with an overall dry thickness of about 0.015 mm and in which 25%, 50%, 75% or 100% of the overall coating represented a modified acrylic finish containing a lightness-inducing pigment. A control coated white tile and a coated polyester sheet each bearing 4 sirnilarly-applied layers of GEMSTAR LASER acrylic finish having an overall dry thickness of about 0.015 mm were also prepared A comparison coated white tile and coated polyester sheet each bearing a similarly-applied layer of the commercial deck stain having an overall dry thickness of about 0.015 mm were also prepared. A comparison coated white tile and coated polyester sheet each bearing 4 layers of the commercial deck seal applied using a No. 50 drawdown bar (0.127 mm wet thickness, commercially available from the Paul N. Gardner Co.) and having an overall dry thickness of about 0.018 mm were also prepared. The coated white tiles were evaluated to determine their whiteness index and gloss values, and the polyester sheets were evaluated to determine their transmittance and absorb ance at 500 nm. A measure of merit was calculated by dividing the whiteness index by the 500 nm absorption value. Several of the finishes were also evaluated to determine their removability using a 1:8 dilution of CARESTRIP LO stripper and a 10 minute stripper contact period. Set out below in Table 7 are the Run No., Formulation No. employed (from Table 6), Number of Formulation layers applied (“No. of Mod. Coats”), Number of GEMSTAR LASER acrylic finish layers applied (“No. of Unmod. Coats”), % Transmittance, Absorbance Coefficient at 500 nm, Whiteness Index, Whiteness Index/Absorbance Coefficient ratio, 20° Gloss, 60° Gloss and the % Removal (chemical stippability) result. The abbreviation “NM” signifies “Not Measured”.

TABLE 7

| | | No. of | No. of | | Absorb. | | | | | |
|---|---|---|---|---|---|---|---|---|---|---|
| Run | Form. | Mod. | Unmod. | | at 500 | | | 20° | 60° | % |
| No. | No. | Coats | Coats | % Trans. | nm | W.I. | WI/Abs | Gloss | Gloss | Removal |
| 4 | 4^{A} | 0 | 4 | 100 | −0.0013 | 45.23 | NM^{B} | 30.9 | 75.0 | 100 |
| 4-1a | 4-1 | 1 | 3 | 96.8 | 0.014 | 46.32 | 3309 | 32.8 | 79.3 | NM |
| 4-1b | 4-1 | 2 | 2 | 92.8 | 0.033 | 45.99 | 1408 | 31.1 | 78.0 | NM |
| 4-1c | 4-1 | 3 | 1 | 87.1 | 0.060 | 46.71 | 779 | 29.3 | 75.6 | NM |
| 4-1d | 4-1 | 4 | 0 | 82.2 | 0.085 | 45.63 | 537 | 32.0 | 78.2 | 100 |
| 4-2a | 4-2 | 1 | 3 | 82.4 | 0.084 | 47.9 | 570 | 43.9 | 86.3 | NM |
| 4-2b | 4-2 | 2 | 2 | 66.2 | 0.18 | 49.84 | 278 | 38.2 | 82.3 | NM |
| 4-2c | 4-2 | 3 | 1 | 48.8 | 0.31 | 50.91 | 163 | 30.5 | 72.6 | NM |
| 4-2d | 4-2 | 4 | 0 | 34.1 | 0.47 | 52.24 | 112 | 11.3 | 30.9 | 100 |
| 4-3a | 4-3 | 1 | 3 | 82.5 | 0.083 | 46.94 | 563 | 39.6 | 85.2 | NM |
| 4-3b | 4-3 | 2 | 2 | 58.7 | 0.23 | 46.12 | 199 | 41.1 | 86.0 | NM |
| 4-3c | 4-3 | 3 | 1 | 48.0 | 0.32 | 46.16 | 145 | 31.7 | 79.9 | NM |
| 4-3d | 4-3 | 4 | 0 | 32.9 | 0.48 | 47.79 | 99 | 35.8 | 83.5 | 100 |
| 4-4a | 4-4 | 1 | 3 | 23.8 | 0.63 | 50.92 | 82 | 40.8 | 85.7 | NM |
| 4-4b | 4-4 | 2 | 2 | 8.6 | 1.06 | 53.74 | 50 | 38.9 | 86.2 | NM |
| 4-4c | 4-4 | 3 | 1 | 1.6 | 1.8 | 58.32 | 32 | 39.9 | 85.9 | NM |
| 4-4d | 4-4 | 4 | 0 | 1.1 | 1.9 | 63.58 | 33 | 17.5 | 64.2 | 100 |
| 4-5 | Deck | 4 | 0 | 0.6 | 2.2 | 71.23 | 32 | 1.7 | 8.5 | 0 |
| | Stain | | | | | | | | | |
| 4-6 | Deck | 1 (#50 | 0 | 0.7 | 2.2 | 57.1 | 27 | 3.9 | 24.4 | 20 |
| | Seal | bar) | | | | | | | | w/wiping |

^{A}Unmodified GEMSTAR LASER finish.
^{B}Not Measured. Because the absorbance was nearly zero, this ratio was very large and of little significance.

Table 7 illustrates the relationship between particle loading and whiteness index for several of the disclosed finishes. As the particle loading increased, the whiteness index also increased. The commercial deck seal and deck stain products had relatively low Whiteness Index/Absorbance ratios, and a poor visual appearance on the tiles.

A lightness evaluation was carried out by applying a single coat of each formulation to LENETA Form N2A opacity charts (commercially available from the Leneta Company) using a No. 7 drawdown bar to provide a dry coating having a thickness of about 0.004 mm. Coatings having a similar thickness were obtained by diluting the deck stain to 20% solids with water and coating the diluted stain on the LENETA chart using a No. 7 drawdown bar, and by applying the deck seal as is using a No. 10 drawdown bar. The color values of the coated areas applied to the black regions of the LENETA Chart were measured as described above in the section entitled Coating Color Values. The L values are shown below in Table 8.

TABLE 8

| | Wt % Pigment | |
|---|---|---|
| | Dispersion | |
| Formulation No. | (Pigment) | L Value |
| 4^{A} | None | 26.42 |
| 4-1 | 5% (ZnO) | 26.98 |
| 4-2 | 22% (ZnO) | 28.48 |
| 4-3 | 5% (TiO₂) | 29.12 |
| 4-4 | 22% (TiO₂) | 37.56 |
| Deck Stain (20% | NM | 55.85 |
| solids) | | |
| Deck Seal (#10 bar) | NM | 42.19 |

^{A}Unmodified GEMSTAR LASER finish.

As shown in Table 8, the chosen pigments increased the measured lightness values. The deck stain and deck seal products had yet higher lightness values but the coating translucencies were sufficiently low so that the underlying black background was noticeably masked.

### EXAMPLE 5

Using the general method of Example 4, floor finish compositions containing a resin based aqueous titanium dioxide dispersion (WFD-5006 aqueous TiO₂ dispersion, 73.3% solids, Sun Chemical Corp.) or ultrafine zinc oxide as used in Example 4 were prepared. The formulations are shown below in Table 9.

TABLE 9

| | | | | Wt % |
|---|---|---|---|---|
| | Lightness- | Wt % | Wt % | Particles in |
| Formulation | Inducing | Pigment | Additional | Dried |
| No. | Pigment | Dispersion | Water | Coating |
| 5^{A} | None | 0 | 0 | 0 |
| 5-1 | ZnO | 14.7 | 23.5 | 38.2 |
| 5-2 | ZnO | 23.8 | 38.1 | 61.9 |
| 5-3 | TiO₂ | 4.65 | 12.8 | 17.4 |
| 5-4 | TiO₂ | 8.2 | 22.7 | 30.9 |

^{A}Unmodified GEMSTAR LASER finish.

A bare area of the Example 1 hallway floor was divided into seven 1.5 m×2.4 m sections, and each was designated as a “Field”. Five formulation layers were applied to each Field as shown below in Table 10, using microfiber mops and a 50 m²/liter wet coating rate In order to saturate the mops before use, 100 g of extra finish was poured onto the floor and the mop was used to soak it up. Between coats, the saturated mops were stored in plastic bags. Each layer was allowed to dry until no longer tacky (about 30-45 minutes) before applying the next layer. The layers identified below as “Unmod.” contained unmodified GEMSTAR LASER finish

TABLE 10

| | Layer | Layer | Layer | Layer | Layer |
|---|---|---|---|---|---|
| Field No. | No. 1 | No. 2 | No. 3 | No. 4 | No. 5 |
| 5-1 | Unmod.^{A} | Unmod. | Unmod. | Unmod. | Unmod. |
| 5-2 | 5-2 | 5-2 | Unmod. | Unmod. | Unmod. |
| 5-3 | 5-3 | 5-3 | Unmod. | Unmod. | Unmod. |
| 5-4 | 5-4 | 5-4 | Unmod. | Unmod. | Unmod. |
| 5-5 | 5-5 | 5-5 | Unmod. | Unmod. | Unmod. |
| 5-6 | Unmod. | Unmod. | Unmod. | Unmod. | 5-1 |
| 5-7 | Unmod. | Unmod. | Unmod. | Unmod. | 5-3 |

^{A}Unmodified GEMSTAR LASER finish.

Fields with undercoats containing a lightness-inducing pigment (Fields 5-2 through 5-5) had a much cleaner and lighter appearance than the field coated with 5 coats of unmodified finish (Field 5-1) yet the tile pattern remained clearly discernible under normal daytime lighting conditions to an observer standing on the Field. Fields 5-2 and 5-3 appeared to be very similar to one another despite their differing zinc oxide pigment levels. However, Fields 5-4 and 5-5 had noticeably different appearances (viz., noticeably different apparent lightness levels). Fields topcoated with one coat of a finish containing lightness-inducing pigments (Fields 5-6 and 5-7) also had a cleaner and lighter appearance than the field coated with five coats of unmodified finish (Field 5-1), but the effect was more subtle and somewhat less noticeable than the fields containing lightness-inducing pigments in the undercoats (Fields 5-2 through 5-5). This may however have been caused by the use of two modified undercoat layers in Fields 5-2 through 5-5 whereas Fields 5-6 and 5-7 employed only one modified topcoat layer.

Two commercially available paints (VALSPAR™ 100% Acrylic White Interior Flat Latex and VALSPAR White Interior/Exterior Gloss Enamel Latex, both from Valspar Corp.) were analyzed to determine their percent solids levels, and determined to contain 58% and 61% solids, respectively using the moisture balance method described above in the section entitled Percent Solids. In order to maintain a constant film thickness for subsequent testing, the paints were diluted to 20% solids by adding about 20 g of the paint to 40 g of deionized water. Drawdowns of the Formulations in Table 9 and the diluted paints were made on LENETA Form 5C opacity charts (commercially available from the Leneta Company) and on 0.127 mm thick clear polyester sheets from GE Polymershapes using a No. 10 Bar from the Paul N. Gardner Co., to provide coatings having an approximate dry coating thickness of about 0.015 mm. The resulting coated films were allowed to air dry for at least 24 hours.

The coated LENATA Form 5C charts were placed over a black background and the color values measured using a COLORQUEST XE color spectrophotometer as described above in the section entitled Coating Color Values. The coated polyester sheets were measured to determine transmittance and absorbance at 500 nm as described above in the section entitled Transmittance and Absorbance, with the polyester sheet coated with Formulation 5 (unmodified GEMSTAR LASER finish) being used as a reference or background sample.

Drawdowns of the Formulations in Table 9 and the undiluted (that is, as supplied) paints were also made on LENETA Form 24B Gray Scale charts (commercially available from the Leneta Company) using a No. 10 Bar. For Formulations 5 and 5-1 through 5-4 a total of three layers were applied to the gray scale chart, with each layer being allowed to air dry before the next layer was applied. For the undiluted paints, one layer was applied to each gray scale chart, thereby yielding a dry coating thickness of about 0.015 mm, comparable to the coating thickness obtained by applying three layers of the 20% solids unmodified and modified floor finish compositions to the gray scale charts. The Hiding Power of each formulation was evaluated as described above in the section entitled Hiding Power.

The Leneta gray scale charts were also used for removability tests. The final coatings were allowed to dry for 24 hours before testing and evaluated to determine strippability using the procedure described above in the section entitled Strippability, a 1:32 dilution of the commercial stripper CARESTRIP LO, and a 2 minute contact time.

The results of these various measurements are set out below in Table 11.

TABLE 11

| Form. | | % | Absorb. At | | WI/ | | Hiding | L/Hiding | % |
|---|---|---|---|---|---|---|---|---|---|
| No. | Pigment | Trans. | 500 nm | W.I. | Absorb. | L Value | Power | Power | Removal |
| 5^{A} | None | NM | NM | 75.11 | NM | 28.73 | 1 | 28.73 | 100 |
| 5-1 | 38% | 46.7 | 0.331 | 74.79 | 226.2 | 37.15 | 1 | 37.15 | 100 |
| | ZnO | | | | | | | | |
| 5-2 | 62% | 38.5 | 0.414 | 74.92 | 181.0 | 37.32 | 1 | 37.32 | 100 |
| | ZnO | | | | | | | | |
| 5-3 | 17% | 23.5 | 0.630 | 74.51 | 118.3 | 40.58 | 1 | 40.58 | 95-100 |
| | TiO₂ | | | | | | | | |
| 5-4 | 31% | 17.9 | 0.746 | 74.96 | 100.5 | 50.82 | 1 | 50.82 | 100 |
| | TiO₂ | | | | | | | | |
| Flat | NM | 3.2 | 1.493 | 72.05 | 48.3 | 69.05 | 4 | 17.3 | 0 |
| White | | | | | | | | | |
| Latex | | | | | | | | | |
| Gloss | NM | 1.9 | 1.729 | 76.25 | 44.1 | 61.30 | 3 | 20.4 | 0 |
| White | | | | | | | | | |
| Enamel | | | | | | | | | |

^{A}Unmodified GEMSTAR LASER finish.

The data in Table 11 show that Formulations 5-1 through 5-4 were strippable and jobsite-renewable whereas the commercial paint products were not strippable using a typical floor finish stripping solution. The ratios for whiteness index;absorbance and L:Hiding Power for formulations 5-1 through 5-4 are significantly greater than the values exhibited by the commercial paints. Higher L:Hiding Power ratios appeared to correlate well with the perceived desirability of appearance. The observers particularly preferred the appearance of tiles coated with Formulations 5-3 and 5-4.

### EXAMPLE 6

Using the general method of Example 4, floor finish compositions employing varying amounts of ACUSOL OP302 organic opacifier (commercially available from Rohm and Haas Co.) as the lightness-inducing pigment were prepared by adding the opacifier/pigment to a 150 g quantity of GEMSTAR POLARIS floor finish (commercially available from Ecolab, Inc.), diluting with water to obtain formulations containing 25% solids, and stirring at 500 rpm for at least 10 minutes using a LIGHTNIN™ overhead mixer (commercially available from the Lightnin Division of SPX Corp.). A 0.6 to 0.77 g portion of each pigment-containing formulation was applied using a formulation-saturated microfiber pad to a one-third area of a white vinyl composition tile (commercially available from the Congoleum Corporation, cleaned as described above in the section entitled Tile Preparation), allowed to dry for at least 30 minutes and evaluated to determine the 20° and 60° gloss values. The formulations and the measured gloss values are shown below in Table 12.

TABLE 12

| Form. | Pigment (g of | | Pigment in | 20° | 60° |
|---|---|---|---|---|---|
| No. | solution) | Water (g) | Finish (%) | Gloss | Gloss |
| 6^{A} | None | None | None | NM | NM |
| 6-1 | 0.48 | 0.3 | 0.5 | 39.6 | 81.2 |
| 6-2 | 0.94 | 0.56 | 1.0 | 30.9 | 74.1 |
| 6-3 | 6.56 | 4.01 | 6.5 | 34.2 | 77.9 |

^{A}Unmodified GEMSTAR POLARIS finish (25% solids).

The coated tile was next overcoated with Formulation No. 6 (viz., the unmodified GEMSTAR POLARIS finish) at a 50 m²/liter coating rate and allowed to dry for at least 30 minutes. En a control run, a 1.9 g portion of Formulation No. 6 was applied to a clean tile (thus giving approximately the same coating rate as was used for the pigment-containing formulations, which were applied to only one-third of a tile), allowed to dry for at least 30 minutes, overcoated with Formulation No. 6 at a 50 m²/liter coating rate and allowed to dry for at least 30 minutes. The thus-coated tiles were evaluate for whiteness index, 20° gloss and 60° gloss. The results are shown below in Table 13.

TABLE 13

| | Whiteness | 20° | 60° |
|---|---|---|---|
| Form. No. | Index | Gloss | Gloss |
| 6 | 44.35 | 52.8 | 89.3 |
| 6-1 | 46.34 | 62.9 | 90.2 |
| 6-2 | 46.95 | 63.6 | 90.9 |
| 6-3 | 45.87 | 62.1 | 91.1 |

The results in Table 13 show that incorporation of an organic opacifier increased the overall whiteness index as compared to a tile coated with only the unmodified finish.

### EXAMPLE 7

Using the general method of Example 4, floor finish compositions employing varying amounts of ACUSOL OP302 organic opacifer as the lightness-inducing pigment were prepared by adding the opacifier/pigment to a 300 g quantity of GEMSTAR LASER floor finish, diluting with water to obtain formulations containing 20% solids, and stirring at 500 rpm for at least 10 minutes using a LIGHTNIN overhead mixer. A 200 mL portion of each resulting formulation was used to saturate a microfiber mop. A 1.67 m² section of the Example 1 laboratory hallway was thoroughly cleaned using a blue nonwoven cleaning pad (commercially available from 3M Company) and neutral cleanser. The saturated mop was used to apply a 35 ml portion of the formulation to the cleaned hallway section and allowed to dry for about 45 to 60 minutes. A second coat was applied using the same saturated mop and another 35 ml portion, and allowed to dry overnight. Meanwhile, two further cleaned hallway sections were coated with GEMSTAR LASER finish applied at a 50 m²/liter coating rate using a finish-saturated microfiber mop, and similarly allowed to dry, recoated and dried overnight. The thus-coated hallway sections were evaluated for whiteness index, 20° gloss and 60° gloss. The results are shown below in Table 14.

TABLE 14

| | Pigment (g | | Pigment in | Whiteness | 20° | 60° |
|---|---|---|---|---|---|---|
| Form. No. | of solution) | Water (g) | Finish (%) | Index | Gloss | Gloss |
| 7, Area | 0 | 0 | 0 | 1.36 | 75.7 | 89.8 |
| No. 1^{A} | | | | | | |
| 7, Area | 0 | 0 | 0 | 2.59 | 70.7 | 93.2 |
| No. 2^{A} | | | | | | |
| 7-1 | 1.5 | 1.52 | 0.5 | 1.70 | 68.9 | 85.5 |

^{A}Unmodified GEMSTAR LASER finish (20% solids).

The results in Table 14 show that incorporation of an organic opacifier increased the overall whiteness index as compared to a first control area but not as compared to a second control area. This result was believed to be due in part to the heterogeneity of the coated tiles, their age, and the relatively low amount of lightness-inducing pigment employed

### EXAMPLE 8

Using the general method of Example 7, floor finish compositions employing varying amounts of ACUSOL OP302 organic opacifier, NANOTEK No. Z1021W ultrafine zinc oxide dispersion in water, or both as lightness-inducing pigments. The formulations were prepared by adding varying quantities of none, one or both pigments to a 10 g quantity of GEMSTAR LASER floor finish and mixing to disperse the ingredients thoroughly. Set out below in Table 15 are the formulations, the grams of pigment solution added and the percent of pigment solids in comparison to the total formulation solids.

TABLE 15

| | | | TiO₂ | |
|---|---|---|---|---|
| | OP302P | OP302P | Pigment | |
| Form. | Pigment (g | Pigment | (g of | TiO₂ Pigment |
| No. | of solution) | (solids %) | solution) | (solids %) |
| 8^{A} | None | None | None | None |
| 8-1 | 2.5 | 33.4 | 0 | 0 |
| 8-2 | 5 | 50.1 | 0 | 0 |
| 8-3 | 10 | 66.7 | 0 | 0 |
| 8-4 | 0 | 0 | 2.5 | 31.7 |
| 8-5 | 5 | 40.7 | 2.5 | 18.8 |

^{A}Unmodified GEMSTAR LASER finish (20% solids).

A clean tile was divided into eight sections. The formulations shown above in Table 15 were individually applied to the first six sections, using approximately a 0.3 g/section coating rate and two coats of the formulation. The last two tile sections were left uncoated. The tile sections were evaluated to determine the output color values in L*A*B coordinates and the whiteness index. The results are shown below in Table 16.

TABLE 16

| | | | | Whiteness |
|---|---|---|---|---|
| Form. No. | L* | a* | b* | Index |
| 8^{A} | 85.7 | −0.52 | 6.04 | 40.82 |
| 8-1 | 86.5 | −0.6 | 5.4 | 44.83 |
| 8-2 | 86.82 | −0.66 | 5.38 | 45.43 |
| 8-3 | 86.46 | −0.56 | 4.71 | 47.71 |
| 8-4 | 87.08 | −0.29 | 2.43 | 58.89 |
| 8-5 | 88.02 | −0.33 | 2.57 | 59.93 |
| None | 86.43 | −0.5 | 5.65 | 43.54 |
| None | 86.43 | −0.5 | 5.65 | 43.54 |

^{A}Unmodified GEMSTAR LASER finish (20% solids).

The results in Table 16 show that addition of OP302P organic opacifier raised the whiteness index from 40.82 to 44.83-47.71 depending on the opacifier concentration, and that the further addition of TiO₂ pigment raised the whiteness index even further.

### EXAMPLE 9

Using the general method of Example 4, floor finish compositions containing ISI STAR floor finish or part A of TUKLAR MEDICAL floor finish (both commercially available from Ecolab, Inc.) were combined with a variety of titanium dioxide pigment dispersions, using sufficient pigment to provide 2.77% pigment solids in the final formulations. Samples of the floor finishes without a pigment addition were used as controls. White and beige vinyl composition tiles were each ruled into quarters. Three coats of each formulation were applied to one-quarter of each tile, using a coating weight of about 0.6 to 0.7 g per coat and a drying time of at least 45 minutes between coats. Gloss values were measured after the top layers had completely dried. Color values were measured after allowing the coated tiles to stand overnight at room temperature. Set out below in Tables 17 and 18 (which respectively report results on white and beige tiles) are the formulation numbers, pigment employed, 20° and 60° gloss values, gloss loss in comparison to the control formulations and the Whiteness Index values.

TABLE 17
White Tiles

| | | | | | 60° | |
|---|---|---|---|---|---|---|
| | | | 20° | | Gloss | |
| | Lightness- | | Gloss | | Loss vs. | |
| Formulation | Inducing | 20° | Loss vs. | 60° | Control | Whiteness |
| No. | Pigment | Gloss | Control (%) | Gloss | (%) | Index |
| 9-A^{A} | None | 23.6 | 0 | 65.4 | 0 | 41.06 |
| | Ti-Pure R- | | | | | |
| 9-1 | 746^{C} | 20.9 | −11.4 | 63.2 | −3.4 | 56.78 |
| | KEMIRA | | | | | |
| 9-2 | RD3^{D} | 13.9 | −41.1 | 53.2 | −18.7 | 58.75 |
| | KEMIRA | | | | | |
| 9-3 | 660^{D} | 16.8 | −28.8 | 58.4 | −10.7 | 53.95 |
| | KEMIRA | | | | | |
| 9-4 | RDE2^{D} | 18.5 | −21.6 | 59.3 | −9.3 | 58.75 |
| | KEMIRA | | | | | |
| 9-5 | RDI-S^{D} | 16.1 | −31.8 | 57 | −12.8 | 55.15 |
| 9-B^{B} | None | 37 | 0 | 78.2 | 0 | 40.19 |
| 9-6 | Ti-Pure R- | 34.8 | −6.0 | 77.2 | −1.3 | 58.51 |
| | 746^{C} | | | | | |

^{A}Unmodified ISI STAR finish.
^{B}Unmodified TUKLAR MEDICAL finish (Part A only).
^{C}Commercially available from E. I. duPont de Nemours and Co.
^{D}Commercially available from Kemira Pigments Oy.

TABLE 18
Beige Tiles

| | | | 20° | | | |
|---|---|---|---|---|---|---|
| | Lightness- | | Gloss | | 60° | |
| Formulation | Inducing | 20° | Loss vs. | 60° | Gloss Loss vs. | Whiteness |
| No. | Pigment | Gloss | Control (%) | Gloss | Control (%) | Index |
| 9-A^{A} | None | 37.6 | 0 | 72.7 | 0 | 14.88 |
| | Ti-Pure R- | | | | | |
| 9-1 | 746^{C} | 27 | −28.2 | 65 | −10.6 | 43.14 |
| | KEMIRA | | | | | |
| 9-2 | RD3^{D} | 22.7 | −39.6 | 61.7 | −15.1 | 47.70 |
| | KEMIRA | | | | | |
| 9-3 | 660^{D} | 22.5 | −40.2 | 61.8 | −15.0 | 41.72 |
| | KEMIRA | | | | | |
| 9-4 | RDE2^{D} | 24.1 | −35.9 | 62.5 | −14.0 | 45.44 |
| | KEMIRA | | | | | |
| 9-5 | RDI-S^{D} | 21.2 | −43.6 | 61 | −16.1 | 41.84 |
| 9-B^{B} | None | 45.4 | 0 | 78 | 0 | 16.49 |
| | Ti-Pure R- | | | | | |
| 9-6 | 746^{C} | 39.4 | −13.2 | 75.5 | −3.2 | 47.01 |

^{A}Unmodified ISI STAR finish.
^{B}Unmodified TUKLAR MEDICAL finish (Part A only).
^{C}Commercially available from E. I. duPont de Nemours and Co.
^{D}Commercially available from Kemira Pigments Oy.

The results in Tables 17 and 18 show that variation in the titanium dioxide pigment could provide variation in lightness enhancement. Especially noticeable lightening and low gloss reduction was obtained for Formulation 9-6.

Various modifications and alterations of this invention will be apparent to those skilled in the art without departing from the scope and spirit of this invention. It should be understood that this invention is not limited to the illustrative embodiments set forth above.

1. A jobsite-renewable floor finish comprising a film former and sufficient lightness-inducing pigment to provide a translucent hardened finish layer having an increased lightness value.

2. A finish according to claim 1 wherein the pigment has a submicron average particle diameter and will diffusely reflect light.

3. A finish according to claim 1 wherein the pigment is designated opaque or semi-opaque by the National Association of Printing Ink Manufacturers in their NPIRI Raw Materials Data Handbook.

4. A finish according to claim 1 wherein the pigment is designated a “pigment white” in the Society of Dyers and Colourists Colour Index.

5. A finish according to claim 1 wherein the pigment comprises zinc oxide, lithopone, titanium dioxide, zinc sulfide, antimony oxide, zirconium oxide, barium sulfate, coprecipitated 3BaSO₄/Al(OH)₃, bismuth oxychloride or mixture thereof.

6. A finish according to claim 1 wherein the pigment comprises titanium dioxide in its rutile form.

7. A finish according to claim 1 wherein the pigment comprises ultrafine zinc oxide.

8. A finish according to claim 1 wherein the pigment comprises an organic particle dispersion.

9. A finish according to claim 1 wherein the film former is water-soluble or water-dispersible.

10. A finish according to claim 1 wherein the film former comprises a water-soluble or water-dispersible acid-containing polymer crosslinked using a transition metal, alkaline earth metal, alkali metal or mixture thereof

11. A finish according to claim 10 wherein the transition metal comprises zinc and the polymer is acrylic.

12. A finish according to claim 1 wherein the film former comprises a radiation-curable polyurethane, polyurethane dispersion, multipart polyurethane or latent one part polyurethane composition containing a blocked isocyanate.

13. A finish according to claim 1 that when coated at a 50 m²/liter coating rate atop patterned vinyl composition floor tiles and evaluated using the L*a*b color space has a lightness value L greater than that obtained in the absence of the pigment and less than about 60.

14. A finish according to claim 13 wherein the lightness value L is less than about 55.

15. A finish according to claim 13 wherein the lightness value L is less than about 50.

16. A finish according to claim 1 wherein the ratio calculated by dividing the lightness value L by the Hiding Power is above about 30, with Hiding Power being determined using a Form 24B Gray Scale chart coated with a 0.015 mm thick layer of hardened finish and measuring the first gray scale bar that can be clearly differentiated from a white background by an observer located three meters from the coated gray scale chart.

17. A finish according to claim 16 wherein the ratio is above about 35.

18. A finish according to claim 1 that when coated at a 50 m²/liter coating rate atop patterned vinyl composition floor tiles and evaluated using the L*a*b color space has a ratio calculated by dividing the whiteness index by the 500 nm absorbance coefficient that is above about 40.

19. A finish according to claim 18 wherein the ratio is above about 80.

20. A finish according to claim 1 containing about 1 to about 75 wt. % pigment based on the total floor finish composition weight.

21. A finish according to claim 1 containing about 2 to about 60 wt. % pigment based on the total floor finish composition weight.

22. A floor coating method comprising applying to a flooring substrate a mixture comprising a film former and sufficient lightness-inducing pigment to provide a translucent jobsite-renewable finish having an increased lightness value.

23. A method according to claim 22 wherein the pigment has a submicron average particle diameter and will diffusely reflect light.

24. A method according to claim 22 wherein the pigment is designated a “pigment white” in the Society of Dyers and Colourists Colour Index.

25. A method according to claim 22 wherein the pigment comprises zinc oxide, lithopone, titania dioxide, zinc sulfide, antimony oxide, zirconium oxide, barium sulfate, coprecipitated 3BaSO₄/Al(OH)₃, bismuth oxychloride or mixture thereof.

26. A method according to claim 22 wherein the pigment comprises titanium dioxide in its rutile form.

27. A method according to claim 22 wherein the pigment comprises ultrafine zinc oxide.

28. A method according to claim 22 wherein the pigment comprises an organic particle dispersion.

29. A method according to claim 22 wherein the film former is water-soluble or water-dispersible.

30. A method according to claim 22 wherein the film former comprises a water-soluble or water-dispersible acid-containing polymer crosslinked using a transition metal, alkaline earth metal, alkali metal or mixture thereof.

31. A method according to claim 30 wherein the transition metal comprises zinc and the polymer is acrylic.

32. A method according to claim 22 wherein the film former comprises a radiation-curable polyurethane, polyurethane dispersion, multipart polyurethane or latent one part polyurethane composition containing a blocked isocyanate.

33. A method according to claim 22 wherein the mixture when coated at a 50 m²/liter coating rate atop patterned vinyl composition floor tiles and evaluated using the L*a*b color space has a lightness value L greater than that obtained in the absence of the pigment and less than about 60.

34. A method according to claim 33 wherein the coated mixture when hard will impart to the floor tiles a cleaner appearance but will permit the pattern to be clearly discerned under normal daytime illumination by an observer standing on the floor tiles.

35. A method according to claim 33 wherein the ratio calculated by dividing the lightness value L by the Hiding Power is above about 30, with Hiding Power being determined using a Form 24B Gray Scale chart coated with a 0.015 mm thick layer of hardened finish and measuring the first gray scale bar that can be clearly differentiated from a white background by an observer located three meters from the coated gray scale chart.

36. A method according to claim 35 wherein the ratio is above about 35.

37. A method according to claim 22 wherein the substrate comprises vinyl sheet flooring, linoleum, rubber sheeting, vinyl composite tiles, rubber tiles, cork or a synthetic sports floor.

38. A method according to claim 22 wherein the substrate comprises concrete, stone, marble, wood, ceramic tile, grout, Terrazzo or a dry shake floor.

39. A method according to claim 22 comprising applying to the substrate a multilayer finish comprising at least one layer of an undercoat and at least one layer of a topcoat having different compositions.

40. A method according to claim 41 wherein at least one layer of the undercoat comprises the pigment

41. A jobsite-renewable floor finish kit comprising instructions for using the kit to apply the floor finish, wherein the kit contains a film former and sufficient lightness-inducing pigment to provide a translucent jobsite-renewable hardened finish having an increased lightness value.

42. A kit according to claim 41 wherein the pigment has a submicron average particle diameter and will diffusely reflect light

43. A kit according to claim 41 wherein the pigment is designated a “pigment white” in the Society of Dyers and Colourists Colour Index.

44. A kit according to claim 41 wherein the pigment comprises zinc oxide, lithopone, titanium dioxide, zinc sulfide, antimony oxide, zirconium oxide, barium sulfate, coprecipitated 3BaSO₄/Al(OH)₃, bismuth oxychloride or mixture thereof.

45. A kit according to claim 41 wherein the pigment comprises titanium dioxide in its rutile form.

46. A kit according to claim 41 wherein the pigment comprises ultrafine zinc oxide.

47. A kit according to claim 41 wherein the pigment comprises an organic particle dispersion.

48. A kit according to claim 41 wherein the film former is water-soluble or water-dispersible.

49. A kit according to claim 41 wherein the film former comprises a water-soluble or water-dispersible acid-containing polymer crosslinked using a transition metal, alkaline earth metal, alkali metal or mixture thereof.

50. A kit according to claim 49 wherein the transition metal comprises zinc and the polymer is acrylic.

51. A kit according to claim 41 wherein the film former comprises a radiation-curable polyurethane, polyurethane dispersion, multipart polyurethane or latent one part polyurethane composition containing a blocked isocyanate.

52. A kit according to claim 41 wherein a mixture of the film former and pigment coated at a 50 m²/liter coating rate atop patterned vinyl composition floor tiles and evaluated using the L*a*b color space has a lightness value L greater than that obtained in the absence of the pigment and less than about 60.

53. A kit according to claim 52 wherein the coated mixture when hardened imparts to the floor tiles a cleaner appearance but permits the pattern to be clearly discerned under normal daytime illumination by an observer standing on the floor tiles.

54. A kit according to claim 52 wherein the ratio calculated by dividing the lightness value L by the Hiding Power is above about 30, with Hiding Power being determined using a Form 24B Gray Scale chart coated with a 0.015 mm thick layer of hardened finish and measuring the first gray scale bar that can be clearly differentiated from a white background by an observer located three meters from the coated gray scale chart.

55. A kit according to claim 54 wherein the ratio is above about 35.

56. A kit according to claim 41 comprising an undercoat and topcoat having different compositions.

57. A kit according to claim 56 wherein at least the undercoat comprises the pigment.
